(19) United States
(12) Patent Application Publication
(10) Pub. No.: US 2011/0034598 A1
(43) Pub. Date: Feb. 10, 2011

(54) PAPER FEED ROLLER

(76) Inventors: Toshihiro TAMURA, Kobe-shi (JP); Akihiro Mine, Kobe-shi (JP); Hirokazu Nishimori, Kobe-shi (JP); Hideyuki Okuyama, Kobe-shi (JP)

Correspondence Address: BIRCH STEWART KOLASCH & BIRCH, PO BOX 747, FALLS CHURCH, VA, 22040-0747, US

(21) Appl. No.: 12/841,194

(22) Filed: Jul. 22, 2010

(30) Foreign Application Priority Data
Aug. 10, 2009 (JP) NO. 2009-185747

(51) Int. Cl. C08K 5/12; C08K 5/10; C08K 5/521

(52) U.S. Cl. 524/147; 524/317; 524/314; 524/310

(57) ABSTRACT

The paper feed roller according to the present invention is made of (1) a thermoplastic elastomer composition containing an ester thermoplastic elastomer urethane (E) having microrubber hardness (type A) of not less than 80 and not more than 95 and at least one plasticizer (P) selected from a group consisting of an ether ester plasticizer and a phthalic ester plasticizer in a mass ratio E/P of 95/5 to 70/30, or (2) a thermoplastic elastomer composition containing an ether thermoplastic elastomer urethane (E) having microrubber hardness (type A) of not less than 80 and not more than 95 and at least one plasticizer (P) selected from a group consisting of an ether ester plasticizer, a phthalic ester plasticizer and a phosphoric acid plasticizer in a mass ratio E/P of 95/5 to 70/30.

### BACKGROUND OF THE INVENTION

1. Field of the Invention

The present invention relates to a paper feed roller employed for paper feeding in an electrostatic copier or a printer.

2. Description of Related Art

A paper feed roller is built in a paper feed mechanism provided in an apparatus such as an electrostatic copier, a laser beam printer, a plain paper facsimile, an ink jet printer or an automatic teller machine (ATM), for example. The paper feed roller includes a feed roller, a transport roller, a platen roller or a paper discharge roller rotating in contact with papers (including plastic films or the like: this also applies to the following description) for transporting the papers by friction.

In general, a rubber roller made of natural rubber, urethane rubber, ethylene-propylene-diene rubber (EPDM), polynorbornene rubber, silicone rubber, chlorinated polyethylene rubber or the like, for example, is employed as the paper feed roller.

The outer peripheral surface of the paper feed roller coming into contact with the papers may be roughened, knurled or embossed, in order to achieve excellent paper feeding by increasing the friction coefficient with respect to the papers. However, the outer peripheral surface subjected to such processing is so easily abraded that the friction coefficient may be reduced due to abrasion upon repetitive contact with the papers, to result in defective transportation of the papers in a relatively early stage.

In recent years, papers containing a large quantity of low-priced extender such as calcium carbonate or talc and a low-priced sizing agent (bleeding inhibitor) prepared from aliphatic hydrocarbon for reducing the cost have been on the market as papers for the aforementioned apparatus. In such papers, however, a large quantity of paper dust results mainly from the calcium carbonate or talc, and easily adheres to the outer peripheral surface of the paper feed roller. Thus, the friction coefficient of the paper feed roller may be reduced due to the adhesion of the paper dust, to cause defective transportation of the papers in a relatively early stage.

Various studies have been made in order to prevent such adhesion of the paper dust. For example, Patent Document 1 (Japanese Unexamined Patent Publication No. 5-125142 (1993)) describes that adhesion of paper dust resulting from static electricity can be suppressed by reducing electric resistance of a paper feed roller. Patent Document 2 (Japanese Unexamined Patent Publication No. 2003-2481) describes that adhesion of paper dust can be suppressed by adding a flaky filler into rubber forming a paper feed roller. Patent Document 3 (Japanese Unexamined Patent Publication No. 2004-299842) describes that adhesion of paper dust can be suppressed by embossing the outer peripheral surface of a paper feed roller and finely irregularizing the embossed outer peripheral surface.

### SUMMARY OF THE INVENTION

According to any of the aforementioned countermeasures, however, the paper dust cannot be sufficiently prevented from adhering to the outer peripheral surface of the paper feed roller.

According to a study made by the inventors, paper dust adheres to the outer peripheral surface of the paper feed roller through the sizing agent prepared from aliphatic hydrocarbon. Further, natural rubber, EPDM, butyl rubber or the like most generally employed for forming the paper feed roller has an SP value (solubility parameter) close to that of the aliphatic hydrocarbon, leading to such high affinity that the aliphatic hydrocarbon contained in the papers easily adheres to the outer peripheral surface of the paper feed roller due to friction between the paper feed roller and the papers. Further, the paper dust easily adheres to the outer peripheral surface through the aliphatic hydrocarbon, and the friction coefficient with respect to the papers is reduced in a short period due to the adhesion. The aliphatic hydrocarbon itself singly functions as an excellent lubricant, to reduce the friction coefficient.

Therefore, the inventors have made deep studies for forming the paper feed roller by a thermoplastic elastomer urethane having an SP value remarkably different from that of aliphatic hydrocarbon with such low affinity that the aliphatic hydrocarbon and paper dust hardly adhere thereto and having superior mechanical strength such as abrasion resistance as compared with the conventional rubber.

Urethane elastomers are roughly classified into a “cast type” urethane elastomer prepared by feeding a liquid material into a mold and solidifying the same into a prescribed shape by crosslinking, a “millable type” urethane elastomer prepared by milling a solid material similarly to general rubber, working the same into a prescribed shape and thereafter crosslinking the same, and a “thermoplastic type” urethane elastomer.

A thermoplastic polyurethane elastomer (thermoplastic elastomer urethane) generally contains a hard segment having a polyurethane structure and a soft segment having a polyester or polyether structure in the molecules. The soft segment performs soft plastic deformation, while the hard segment prevents (restrains) the plastic deformation similarly to a crosslinking point of vulcanized rubber.

Due to the actions of the soft and hard segments, the thermoplastic elastomer urethane allows fusion molding by injection molding or extrusion molding similarly to general thermoplastic resin, while exhibiting rubber elasticity similar to that of vulcanized rubber. In injection molding, a thermoplastic elastomer composition (may hereinafter be abbreviated as “TPU”) prepared by blending a plasticizer etc. into a thermoplastic elastomer urethane can be molded into a prescribed shape by injecting the same into a mold in a state heated to not less than the melting point or the glass transition temperature thereof to be fused and thereafter solidifying the same by cooling. In extrusion molding, the fused TPU can be molded into an elongated product having a prescribed sectional shape by extruding the same from a die and thereafter solidifying the same by cooling. The material itself is supplied in the form of a pellet or the like similarly to thermoplastic resin, to be extremely easy to handle.

The TPU, requiring a far shorter molding cycle than the cast type urethane elastomer, having high mass productivity and requiring no milling or crosslinking step dissimilarly to the millable type urethane elastomer, is known as a material superior in moldability to the remaining ones.

However, the range of material selection for the thermoplastic elastomer urethane employed as the chief material for the TPU is limited due to the thermoplasticity, and the physical properties of the thermoplastic elastomer urethane represented by hardness are limited in particular. If the hardness of the thermoplastic elastomer urethane is reduced, mechanical strength such as abrasion resistance is reduced, or moldability such as a solidification rate in cooling after fusion molding is remarkably reduced. Therefore, the lower limit of the hardness of a generally usable thermoplastic elastomer urethane is set to 60 in microrubber hardness (type A) measured with a microrubber hardness tester “MD-1” by Kobunshi Keiki Co., Ltd., for example, under an environment having a temperature of 23±1° C. and relative humidity of 55±1%.

While a soft thermoplastic elastomer urethane having microrubber hardness (type A) of less than 60 is put on the market as a material, a TPU containing the soft thermoplastic elastomer urethane is not suitable for fusion molding. The TPU containing the soft thermoplastic elastomer urethane has such a low solidification rate that the same is not sufficiently solidified even if a molded product thereof is cooled to room temperature over a long cooling time after injection molding, for example, and easily deformed upon demolding. Even if the molded product can be demolded without deformation, abrasion resistance thereof is so inferior that the friction coefficient with respect to papers is remarkably reduced or precision in paper feeding is remarkably reduced due to friction. Therefore, a practicable paper feed roller cannot be formed by the TPU containing the soft thermoplastic elastomer urethane.

On the other hand, a TPU containing a hard thermoplastic elastomer urethane having microrubber hardness (type A) of not less than 60 does not cause the aforementioned problems. However, a paper feed roller formed by the TPU is not sufficiently deflected in paper feeding due to the hardness. Therefore, the paper feed roller already exhibits a low friction coefficient with respect to papers in an early stage of use, and cannot achieve excellent paper feeding.

In other words, one of important factors influencing the friction coefficient of the paper feed roller with respect to the papers is a large contact length (nip width) between the paper feed roller, brought into contact with the papers with a prescribed pressure and deflected, and the papers in the paper feeding direction. As the contact length is increased, the friction coefficient can be increased by increasing the contact area, expressed by the product of the contact length and the width of the papers orthogonal to the paper feeding direction, between the paper feed roller and the papers. In a conventional TPU containing a hard thermoplastic elastomer urethane, however, the contact length cannot be sufficiently increased.

An object of the present invention is to provide a paper feed roller made of a TPU excellent in moldability and abrasion resistance and hardly causing reduction of the friction coefficient resulting from adhesion of paper dust or reduction of the precision in paper feeding resulting from friction, flexible, easily deflected when brought into contact with papers with a prescribed pressure, and provided with a high friction coefficient with respect to the papers from an early stage of use to hardly cause defective paper feeding over a long period from the early stage of use.

The paper feed roller according to the present invention is made of:

(1) a thermoplastic elastomer composition (TPU) containing an ester thermoplastic elastomer urethane (E) having microrubber hardness (type A) of not less than 80 and not more than 95 and at least one plasticizer (P) selected from a group consisting of an ether ester plasticizer and a phthalic ester plasticizer in a mass ratio E/P of 95/5 to 70/30, or

(2) a thermoplastic elastomer composition (TPU) containing an ether thermoplastic elastomer urethane (E) having microrubber hardness (type A) of not less than 80 and not more than 95 and at least one plasticizer (P) selected from a group consisting of an ether ester plasticizer, a phthalic ester plasticizer and a phosphoric acid plasticizer in a mass ratio E/P of 95/5 to 70/30.

According to the present invention, the microrubber hardness (type A) of the thermoplastic elastomer urethane is in the range of not less than 80 and not more than 95. Therefore, the thermoplastic elastomer urethane having the microrubber hardness in the aforementioned range and exhibiting excellent moldability and excellent abrasion resistance is so employed that a paper feed roller hardly allowing adhesion of aliphatic hydrocarbon or paper dust due to a high SP value specific to the thermoplastic elastomer urethane and not remarkably reducing the friction coefficient can be formed by arbitrary molding such as injection molding without causing a defect such as deformation resulting from insufficient solidification.

Further, the TPU is provided with proper flexibility due to the addition of the prescribed quantity of the specific plasticizer to the thermoplastic elastomer urethane. Therefore, the paper feed roller made of the TPU has a high friction coefficient with respect to the papers from an early stage of use.

In addition, the TPU maintains the excellent abrasion resistance of the thermoplastic elastomer urethane, due to the addition of the prescribed quantity of the specific plasticizer to the thermoplastic elastomer urethane. Therefore, the paper feed roller made of the TPU is also excellent in abrasion resistance. Further, there is no possibility that the friction coefficient with respect to the paper is remarkably reduced in a short period or the precision in paper feeding is reduced due to a change in the outer diameter or the like.

According to the present invention, therefore, a paper feed roller hardly causing defective paper feeding over a long period from the early stage of use can be formed.

When an ester thermoplastic elastomer urethane containing a soft segment having a polyester structure is employed, at least one plasticizer selected from the group consisting of the ether ester plasticizer, particularly mono- or more oxyalkylene glycol diester, and the phthalic ester plasticizer, particularly phthalic diester having an oxyalkylene skeleton, is preferably employed as the plasticizer.

When an ether thermoplastic elastomer urethane containing a soft segment having a polyether structure is employed, on the other hand, at least one plasticizer selected from the group consisting of the ether ester plasticizer, particularly mono- or more oxyalkylene glycol diester, the phthalic ester plasticizer, particularly phthalic diester having an oxyalkylene skeleton, and the phosphoric acid plasticizer, particularly phosphoric ester having an oxyalkylene skeleton, is preferably employed as the plasticizer.

According to such a combination of the thermoplastic elastomer urethane and the plasticizer, the friction coefficient with respect to the papers can be further improved by increasing the flexibility while maintaining the excellent abrasion resistance of the paper feed roller, as clearly understood from the results of Examples described later.

The thermoplastic elastomer urethane of any of the aforementioned types is synthesized by addition-polymerizing diisocyanate, macropolyol and a chain extender. The compounding ratio of the components constituting the addition polymer preferably satisfies the following formula (1):

30≦(x+z)/(x+y+z)×100≦40 (1)

(where x, y and z represent the loadings of diisocyanate, macropolyol and the chain extender respectively). The compounding ratio of the components is so set in the aforementioned range that the microrubber hardness (type A) of the produced addition polymer, i.e., the thermoplastic elastomer urethane can be adjusted in the aforementioned range.

The microrubber hardness (type A) of the paper feed roller made of the TPU containing the components is preferably not less than 60 and not more than 90. If the microrubber hardness (type A) is less than 60, the paper feed roller may be insufficient in abrasion resistance, although the same is flexible and has an excellent friction coefficient with respect to papers in an early stage of use. Therefore, the paper feed roller may not be capable of maintaining the excellent friction coefficient over a long period.

If the microrubber hardness (type A) exceeds 90, on the other hand, the paper feed roller is not sufficiently deflected in paper feeding due to the hardness, and hence the friction coefficient with respect to the papers may already be so low in the early stage of use that excellent paper feeding cannot be achieved.

Each of the rubber hardness of the thermoplastic elastomer urethane and the rubber hardness of the inventive paper feed roller made of the TPU containing the thermoplastic elastomer urethane is defined by the microrubber hardness (type A) in the present invention since the rubber thickness may be so excessively small that the rubber hardness cannot be measured with a general spring rubber hardness tester particularly in the paper feed roller.

According to the present invention, therefore, the rubber hardness of the paper feed roller is defined by the microrubber hardness (type A). The structure and the effects of the present invention can be further clarified by defining the rubber hardness of the thermoplastic elastomer urethane for forming the paper feed roller by the same microrubber hardness (type A).

The microrubber hardness (type A) is expressed by a value measured with the microrubber hardness tester “MD-1” by Kobunshi Keiki Co., Ltd. under the environment having the temperature of 23±1° C. and the relative humidity of 55±1%, as hereinabove described.

The microrubber hardness tester “MD-1” has been developed in order to measure the rubber hardness of a fine component or a thin sheet, which has been hard to measure with a conventional spring rubber hardness tester. In the type A, a measured value approximate to the spring A hardness defined in JIS K6301:1995 “physical testing methods for vulcanized rubber”, i.e., the so-called JIS A hardness can be obtained by measuring the hardness under conditions of a load system of a cantilever plate spring, a cylindrical indenter having a diameter of 0.16 mm and a height of 0.5 mm, a pressure leg having an outer diameter of 4.0 mm and an inner diameter of 1.5 mm and spring loads of 22 mN (2.24 g) in 0 points and 332 mN (33.85 g) in 100 points.

More specifically, a sample is prepared by superposing four sheets of 2 mm in thickness singly made of the thermoplastic elastomer urethane whose hardness is to be measured. The indenter is pushed into the sample on five positions of the surface thereof in the thickness direction of the sheets, to obtain the average rubber hardness as the microrubber hardness (type A) of the thermoplastic elastomer urethane. Further, the indenter is pushed into the outer peripheral surface of the paper feed roller on five positions in the radial direction of the paper feed roller, to obtain the average rubber hardness as the microrubber hardness (type A) of the paper feed roller.

According to the present invention, the paper feed roller is made of the TPU excellent in moldability and abrasion resistance and hardly causing reduction of the friction coefficient resulting from adhesion of paper dust or reduction of the precision in paper feeding resulting from friction, flexible, easily deflected when brought into contact with papers with a prescribed pressure, and has a high friction coefficient with respect to the papers from an early stage of use. Therefore, the paper feed roller hardly causes defective paper feeding over a long period from the early stage of use, and is excellent in abrasion resistance.

The foregoing and other objects, features and effects of the present invention will become more apparent from the following detailed description of the embodiments with reference to the attached drawings.

### BRIEF DESCRIPTION OF THE DRAWING

FIG. 1 is a perspective view showing a paper feed roller according to an embodiment of the present invention.

### DETAILED DESCRIPTION OF PREFERRED EMBODIMENTS

(Thermoplastic Elastomer Composition)

A thermoplastic elastomer composition (TPU) for forming the paper feed roller according to the present invention contains an ester thermoplastic elastomer urethane or an ether thermoplastic elastomer urethane (E) having microrubber hardness (type A) of not less than 80 and not more than 95 and a plasticizer (P) in a mass ratio E/P of 95/5 to 70/30.

The microrubber hardness (type A) of the thermoplastic elastomer urethane is limited to not less than 80 and not more than 95 for the following reason: A paper feed roller made of a soft thermoplastic elastomer urethane having microrubber hardness (type A) of less than 80 is insufficient in abrasion resistance and cannot withstand use over a long period, although the same is flexible and exhibits an excellent friction coefficient with respect to papers in an early stage of use.

When a hard thermoplastic elastomer urethane having microrubber hardness (type A) exceeding 95 is used, on the other hand, the plasticizer must be blended in a large quantity exceeding the mass ratio E/P=70/30 of the thermoplastic elastomer urethane (E) and the plasticizer (P). Therefore, the excess plasticizer bleeds from the paper feed roller to disadvantageously contaminate papers or the like.

When the microrubber hardness (type A) of the thermoplastic elastomer urethane is not less than 80 and not more than 95, a paper feed roller having excellent characteristics can be formed without causing the aforementioned problems.

According to the present invention, the mass ratio E/P of the thermoplastic elastomer urethane (E) and the plasticizer (P) is limited to 95/5 to 70/30 for the following reasons: If the content of the plasticizer exceeds the aforementioned range, the abrasion resistance of the paper feed roller may be so reduced that the excellent friction coefficient cannot be maintained over a long period or the excess plasticizer bleeds from the paper feed roller to disadvantageously contaminate the papers or the like.

If the content of the plasticizer is less than the aforementioned range, on the other hand, the effect of the plasticizer providing flexibility to the paper feed roller cannot be attained, and a paper feed roller having a high friction coefficient in an initial stage of use cannot be formed.

When the mass ratio E/P of the thermoplastic elastomer urethane (E) and the plasticizer (P) is 95/5 to 70/30, a paper feed roller having excellent characteristics can be formed without causing the aforementioned problems. In order to form a paper feed roller having more excellent characteristics, the mass ratio E/P is preferably 90/10 to 80/20 in the aforementioned range.

The thermoplastic elastomer urethane is synthesized by addition-polymerizing diisocyanate, macropolyol and a chain extender, similarly to the prior art.

The diisocyanate can be prepared from not less than one or two of tolylene diisocyanate (TDI), 4,4′-diphenylmethane diisocyanate (MDI), 1,5-naphthylene diisocyanate (NDI), tolidine diisocyanate, 1,6-hexamethylene diisocyanate (HDI), isophorone diisocyanate (IPDI), xylylene diisocyanate (XDI), hydrogenated XDI, tetramethylxylene diisocyanate (TMXDI), 1,8-diisocyanate methyloctane and dicyclohexylmethane diisocyanate (hydrogenated MDI: HMDI). In particular, 4,4′-diphenylmethane diisocyanate (MDI) is preferable.

The macropolyol can be prepared from polyester polyol or polyetherpolyol. The number average molecular weight Mn of the macropolyol is preferably not less than 500 and not more than 5000, particularly preferably not less than 1000 and not more than 3000. When polyester polyol is employed as the macropolyol, an ester thermoplastic elastomer urethane containing a soft segment having a polyester structure is synthesized. When polyether polyol is employed as the macropolyol, on the other hand, an ether thermoplastic elastomer urethane containing a soft segment having a polyether structure is synthesized.

The polyester polyol can be obtained by dehydration condensation of not less than one or two of bivalent organic acid and acid ester thereof or an ester-forming derivative such as anhydride and not less than one or two aliphatic diols, for example.

The bivalent organic acid can be prepared from aliphatic dicarboxylic acid (succinic acid, glutaric acid, adipic acid, sebacic acid, azelaic acid or the like) having a carbon number of 4 to 12, aromatic dicarboxylic acid (phthalic acid, terephthalic acid, isophthalic acid, naphthalene dicarboxylic acid or the like) or cycloaliphatic dicarboxylic acid (hexahydrophthalic acid, hexahydroterephthalic acid, hexahydroisophthalic acid or the like), for example.

The aliphatic diol can be prepared from aliphatic diol having a carbon number of 2 to 10 such as ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,3-octanediol or 1,9-nonanediol, for example.

The polyester polyol can be prepared from polylactonediol obtained by ring-opening polymerization of a lactone monomer such as ε-caprolactone, for example.

The polyester polyol is preferably prepared from poly(tetramethylene adipate-co-hexamethylene adipate) glycol.

On the other hand, the polyether polyol can be prepared from polyethylene glycol, polypropylene glycol or polytetramethylene glycol obtained by polymerizing cyclic ether such as ethylene oxide, propylene oxide or tetrahydrofuran, or not less than one or two copolyethers obtained by copolymerizing not less than two of such cyclic ethers, for example. In particular, polytetramethylene glycol is preferable.

The chain extender can be prepared from not less than one or two of aliphatic polyol, cycloaliphatic polyol and aromatic polyol, for example.

The aliphatic polyol can be prepared from not less than one or two of ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol and diethylene glycol, for example.

The cycloaliphatic polyol can be prepared from 1,4-cyclohexane dimethanol, for example.

The aromatic polyol can be prepared from not less than one or two of 1,4-dimethylolbenzene, bisphenol A, an ethylene oxide adduct of bisphenol A and a propylene oxide adduct of bisphenol A, for example.

The chain extender can also be prepared from amine. The amine can be prepared from dicyclohexylmethyl methanediamine (hydrogenated MDA) or isophorone diamine (IPDA), for example.

The chain extender is preferably prepared from 1,4-butanediol.

With the aforementioned components, the thermoplastic elastomer urethane can be synthesized by a method similar to a conventional one. According to a one-shot method, for example, the thermoplastic elastomer urethane is synthesized by mixing the chain extender into the macropolyol previously dehydrated by heating under reduced pressure or the like, stirring the mixture under heating, adding separately heated diisocyanate and further stirring the mixture under heating for a constant time thereby addition-polymerizing the components. The synthesized thermoplastic elastomer urethane can be heated to a prescribed temperature to be annealed, pulverized and thereafter pelletized, to be employed as the raw material for the TPU.

Alternatively, a mixture obtained by mixing the components with one another by performing the addition polymerization in a batch system or a continuous system can be continuously extruded through an extruder, for example, or continuously transported on a conveyor belt, maintained at a temperature of not less than 40° C. and not more than 230° C., preferably not less than 70° C. and not more than 180° C. for a constant time, reacted and thereafter pelletized, to be employed as the raw material for the TPU.

The compounding ratio of the components is preferably in the range satisfying the formula (1):

30≦(x+z)/(x+y+z)×100≦40 (1)

(where x, y and z represent the loadings of diisocyanate, macropolyol and the chain extender respectively). The compounding ratio of the components is so set in the aforementioned range that the microrubber hardness (type A) of the produced thermoplastic elastomer urethane can be adjusted in the aforementioned range.

The TPU is preferably pelletized, in order to improve handle ability etc. in injection molding or extrusion molding. A pellet of the TPU can be manufactured by supplying a pellet of the thermoplastic elastomer urethane as the raw material and the plasticizer to a double-screw extruder, for example, to be in the aforementioned prescribed mass ratio E/P, milling and continuously extruding the materials with the double-screw extruder and thereafter pelletizing the same again. A prescribed quantity of the plasticizer may be measured and supplied to the double-screw extruder.

Alternatively, a pellet of the TPU can be manufactured by blending a pellet of the thermoplastic elastomer urethane and the plasticizer with each other to be in the prescribed mass ratio E/P, storing the mixture in a container and heating the same for a constant time thereby impregnating the plasticizer into the pellet and thereafter pelletizing the mixture again while continuously extruding the same with an extruder.

When the ester thermoplastic elastomer urethane is employed, at least one plasticizer selected from the group consisting of the ether ester plasticizer and the phthalic ester plasticizer is selectively employed as the plasticizer. When the ether thermoplastic elastomer urethane is employed, on the other hand, at least one plasticizer selected from the group consisting of the ether ester plasticizer, the phthalic ester plasticizer and the phosphoric acid plasticizer is selectively employed as the plasticizer.

Even if a plasticizer other than the above is blended with the thermoplastic elastomer urethane having the microrubber hardness (type A) of not less than 80 and not more than 95 in the mass ratio E/P=95/5 to 70/30 of the thermoplastic elastomer urethane (E) and the plasticizer (P), the effect of providing flexibility to the paper feed roller cannot be attained, and a paper feed roller having a high friction coefficient in an initial stage of use cannot be formed.

In order to provide proper flexibility to the paper feed roller with the plasticizer other than the above, the plasticizer must be blended in a large quantity exceeding the mass ratio E/P of 70/30. In this case, the abrasion resistance of the paper feed roller is so reduced by the large quantity of the plasticizer that the excellent friction coefficient cannot be maintained over a long period or the excess plasticizer bleeds from the paper feed roller to contaminate the papers or the like.

The plasticizer combined with the ester thermoplastic elastomer urethane is preferably prepared from at least one plasticizer selected from the group consisting of the ether ester plasticizer, particularly mono- or more oxyalkylene glycol diester including mono oxyalkylene glycol diesther, dioxyalkylene glycol diester, trioxyalkylene glycol diester . . . or the like and the phthalic ester plasticizer, particularly phthalic ester having an oxyalkylene structure.

On the other hand, the plasticizer combined with the ether thermoplastic elastomer urethane is preferably prepared from at least one plasticizer selected from the group consisting of the ether ester plasticizer, particularly mono- or more oxyalkylene glycol diester, the phthalic ester plasticizer, particularly phthalic ester having an oxyalkylene structure, and the phosphoric acid plasticizer, particularly phosphoric ester having an oxyalkylene structure.

The TPU can also contain various additives such as a filler, a hydrolysis inhibitor, an antioxidant and a colorant, for example, in addition to the components. The additives can be introduced into the TPU in an arbitrary stage from the synthesis of the thermoplastic elastomer urethane to the pelletization of the TPU.

For example, the hydrolysis inhibitor, employed for preventing the ester thermoplastic elastomer urethane from deterioration resulting from hydrolysis, can be previously added to the aforementioned reaction system for addition-polymerizing the diisocyanate, the macropolyol and the chain extender.

The antioxidant, employed for preventing the ether thermoplastic elastomer urethane from deterioration resulting from oxidation, can be previously added to the aforementioned reaction system for addition-polymerizing the diisocyanate, the macropolyol and the chain extender.

(Paper Feed Roller)

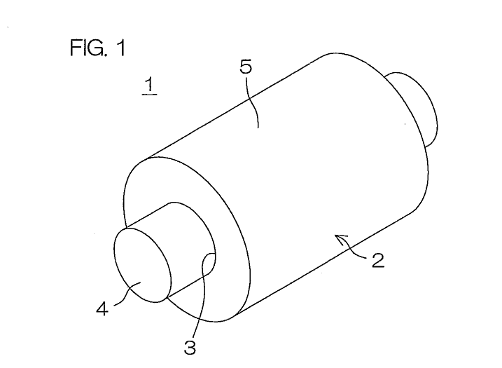

FIG. 1 is a perspective view showing an embodiment of the paper feed roller according to the present invention.

Referring to FIG. 1, a paper feed roller 1 according to the embodiment includes a cylindrical roller body 2 made of the TPU and a shaft 4 inserted into a through-hole 3 at the center of the roller body 2. The outer diameter of the shaft 4 is set to be greater than the inner diameter of the through-hole 3 not yet receiving the shaft 4. The shaft 4 is press-fitted into the through-hole 3, to be fixed to the roller body 2 and integrally rotated therewith. The shaft 4 is integrally made of a metal, a ceramic or hard resin, for example.

The rubber thickness of the roller body 2, not particularly restricted, is preferably not less than 1 mm and not more than 20 mm, particularly preferably not less than about 2 mm and not more than about 15 mm, in order to achieve excellent paper feeding when the paper feed roller 1 is employed for an electrostatic copier, for example. The roller body 2 is formed by arbitrary molding such as injection molding or extrusion molding with the TPU.

In the injection molding, the aforementioned pelletized TPU is milled in an injection molder along with arbitrary additives if necessary, heated and melted, injected into a mold corresponding to the cylindrical shape of the roller body 2, cooled, solidified and thereafter demolded, to form the roller body 2.

In the extrusion molding, on the other hand, the TPU is milled in an extrusion molder along with arbitrary additives if necessary, heated and melted, extruded into a long cylindrical shape through a die corresponding to the sectional shape of the roller body 2, i.e., an annular shape, cooled, solidified and thereafter cut into a prescribed length, to form the roller body 2.

Then, the shaft 4 is press-fitted into the through-hole 3 of the formed roller body 2. At an arbitrary time around the press-fitting, an outer peripheral surface 5 of the roller body 2 is polished to have prescribed surface roughness, the outer peripheral surface 5 is knurled or embossed, or both ends of the roller body 2 are cut so that the axial length of the roller body 2, i.e., the width of the paper feed roller 1 reaches a prescribed value. Thus, the paper feed roller 1 shown in FIG. 1 is manufactured.

The roller body 2 may have a two-layer structure including an outer layer on the side of the outer peripheral surface 5 and an inner layer on the side of the shaft 4. In this case, at least the outer layer may be made of the TPU.

Depending on the application of the paper feed roller 1, the through-hole 3 may be provided on a position eccentric to the roller body 2. The roller body 2 is not restricted to the cylindrical shape, but may have such a variant shape that the outer peripheral surface 5 is partially notched in a planar manner, for example. The roller body 2 may be directly molded into the variant shape by injection molding or extrusion molding, or the outer peripheral surface 5 of the cylindrically formed roller body 2 may be post-worked into the variant shape.

Alternatively, the cylindrically formed roller body 2 can be deformed into the variant shape by press-fitting the shaft 4, whose section is deformed into a shape corresponding to the variant shape, into the through-hole 3. In this case, the outer peripheral surface 5 can be polished, knurled or embossed in the state of the undeformed cylindrical roller body 2, whereby the workability can be improved.

The paper feed roller 1 according to the present invention can be employed as a paper feed roller such as a feed roller, a transport roller, a platen or a paper discharge roller built in a paper feed mechanism provided in an apparatus such as an electrostatic copier, a laser beam printer, a plain paper facsimile, an ink jet printer or an automatic teller machine (ATM), for example.

The rubber hardness of the paper feed roller 1 according to the present invention, i.e., the rubber hardness of the roller body 2 in the embodiment shown in FIG. 1, is preferably not less than 60 and not more than 90 in microrubber hardness (type A). If the microrubber hardness (type A) is not more than 60, the roller body 2 is flexible and has an excellent friction coefficient with respect to papers in an early stage of use. In this case, however, the roller body 2 may be insufficient in abrasion resistance, and may not be capable of maintaining the excellent friction coefficient over a long period.

If the microrubber hardness (type A) exceeds 90, on the other hand, the roller body 2 is not sufficiently deflected in paper feeding due to the hardness, and hence the friction coefficient with respect to the papers may be so low in the early stage of use that excellent paper feeding cannot be achieved.

The microrubber hardness (type A) of the roller body 2 is more preferably not less than 70 and not more than 75 in the aforementioned range, in order to form the paper feed roller 1 having excellent characteristics without causing the aforementioned problems.

### Examples

### Synthetic Example 1

Poly(tetramethylene adipate-co-hexamethylene adipate) [number average molecular weight Mn=2000] as polyester polyol was heated to 110° C. under reduced pressure of 5 hPa and dehydrated for one hour.

Then, 160.6 parts by mass of 1,4-butanediol as a chain extender was mixed to 2000 parts by mass of the poly (tetramethylene adipate-co-hexamethylene adipate) and the mixture was stirred under heating to 80° C., while 696.5 parts by mass of 4,4′-diphenylmethane diisocyanate as diisocyanate and 13 parts by mass of Stabaxol (registered trademark) I by Rhein Chemie Rheinau as a hydrolysis inhibitor were added to the mixture, which in turn was further continuously stirred.

When the reaction temperature reached 110° C., the mixture was poured onto a hot plate covered with glass fiber cloth processed with Teflon (registered trademark) and heated to 125° C., and the reaction product was annealed in a drying chamber of 100° C. for 15 hours, pulverized and thereafter pelletized, to prepare a pellet of an ester thermoplastic elastomer urethane.

A sample was prepared by superposing four sheets of 2 mm in thickness obtained from the pellet, and an indenter of a microrubber hardness tester (MD-1 by Kobunshi Keiki Co., Ltd.) was pushed into the sample on five positions of the surface thereof in the thickness direction of the sheets, under an environment having a temperature of 23±1° C. and relative humidity of 55±1%, to obtain the average rubber hardness as the microrubber hardness (type A) of the thermoplastic elastomer urethane. As a result, the microrubber hardness was 80. The compounding ratio of the components obtained according to the formula (1) was 30.0.

### Synthetic Example 2

A pellet of an ester thermoplastic elastomer urethane was prepared similarly to synthetic example 1, except that the quantities of 1,4-butanediol and 4,4′-diphenylmethane diisocyanate were set to 256 parts by mass and 960 parts by mass respectively. The microrubber hardness (type A) of the thermoplastic elastomer urethane obtained similarly to the above was 90. The compounding ratio of the components obtained according to the formula (1) was 37.8.

### Synthetic Example 3

A pellet of an ester thermoplastic elastomer urethane was prepared similarly to synthetic example 1, except that the quantities of 1,4-butanediol and 4,4′-diphenylmethane diisocyanate were set to 105 parts by mass and 542 parts by mass respectively. The microrubber hardness (type A) of the thermoplastic elastomer urethane obtained similarly to the above was 70. The compounding ratio of the components obtained according to the formula (1) was 24.4.

### Synthetic Example 4

A pellet of an ester thermoplastic elastomer urethane was prepared similarly to synthetic example 1, except that the quantities of 1,4-butanediol and 4,4′-diphenylmethane diisocyanate were set to 323.4 parts by mass and 1149 parts by mass respectively. The microrubber hardness (type A) of the thermoplastic elastomer urethane obtained similarly to the above was 98. The compounding ratio of the components obtained according to the formula (1) was 42.4.

### Example 1

80 parts by mass of the pellet of the thermoplastic elastomer urethane prepared according to synthetic example 1 and 20 parts by mass of diisopropylene glycol dibenzoate (Benzoflex 988 (registered trademark) by Velsicol Chemical Corporation) were introduced into a pail and heated in an oven of 80° C. for 15 hours to impregnate the plasticizer into the pellet. Thereafter the total contents of the pail were supplied to a double-screw extruder (screw diameter: 30 mm, L/D: 36D, number of revolutions: 10 to 300 rpm), milled and continuously extruded with the double-screw extruder, and thereafter pelletized again to manufacture a pellet of the TPU. The extrusion conditions were set to number of revolutions of screw of 120 rpm and a resin temperature of 180° C. The mass ratio E/P of the thermoplastic elastomer urethane and the plasticizer was 80/20.

Then, the pellet was supplied to a 50-ton injection molder (by Sumitomo Heavy Industries, Ltd.). Then, the pellet was milled with the injection molder, injected into a mold in a heated and melted state, cooled, solidified and thereafter demolded to form a cylindrical roller body 2 having an outer diameter of 14 mm, an inner diameter of 7.7 mm and an axial length of 40 mm, as shown in FIG. 1.

Then, a temporary shaft having a diameter of 8 mm was press-fitted into a through-hole 3 of the roller body 2, the roller body 2 was cut into an axial length of 25 mm, and a stainless steel shaft 4 having a diameter of 8 mm was press-fitted into the through-hole 3 again. An outer peripheral surface 5 of the roller body 2 was polished until the outer diameter reached 12.7 mm, to form a paper feed roller 1. The rubber hardness of the roller body 2 was 2.35 mm.

### Example 2 and Comparative Example 1

Pellets of TPUs were manufactured similarly to Example 1, except that the pellets of the thermoplastic elastomer urethanes prepared according to synthetic example 2 (Example 2) and synthetic example 4 (comparative example 1) respectively were employed while the quantities of each of the pellets and diisopropylene glycol dibenzoate as an ether ester plasticizer were set to 90 parts by mass and 10 parts by mass respectively. In each TPU, the mass ratio E/P of the thermoplastic elastomer urethane and the plasticizer was 90/10.

### Comparative Example 2

A pellet of a TPU was manufactured similarly to Example 1, except that the pellet of the thermoplastic elastomer urethane prepared according to synthetic example 3 was employed. The mass ratio E/P of the thermoplastic elastomer urethane and the plasticizer was 80/20.

The characteristics of the pellets of the TPUs and the paper feed rollers 1 manufactured according to Examples 1 and 2 and comparative examples 1 and 2 were evaluated by conducting the following tests under an environment having a temperature of 23±1° C. and relative humidity of 55±1%.

(Moldability Test)

Each of the TPUs prepared according to Examples 1 and 2 and comparative examples 1 and 2 was supplied to the aforementioned injection molder. Then, the TPU was milled with the injection molder and injected into a mold in a heated and melted state, cooled, solidified and thereafter demolded to form a compressed ball defined in JIS K 6262:2006 “rubber, vulcanized or thermoplastic—determination of compression set at ambient, elevated or low temperatures”. A cooling time required to the compressed ball having a prescribed shape to be demoldable without deformation or the like was measured. The measurement conditions were set to a resin temperature of 190° C. and a mold temperature of 15° C. The moldability was evaluated with the following criteria:

◯: The cooling time was less than 180 seconds, and the moldability was excellent.

Δ: The cooling time was not less than 180 seconds and less than 600 seconds, and the moldability was in the practical range.

×: The compressed ball was not sufficiently solidified even if the cooling time was not less than 600 seconds, and so deformed in demolding that it was impossible to demold the compressed ball in a state keeping the prescribed shape. The moldability was inferior.

(Hardness Measurement)

The average rubber hardness of each of the paper feed rollers 1 formed according to Examples 1 and 2 and comparative examples 1 and 2 was obtained by pushing the indenter of the microrubber hardness tester (MD-1 by Kobunshi Keiki Co., Ltd.) into five positions of the outer peripheral surface 5 of the roller body 2 in the radial direction of the paper feed roller 1. The obtained average hardness was regarded as the microrubber hardness (type A) of the roller body 2.

(Abrasion Resistance Test)

The outer diameter of a central portion of the paper feed roller 1 formed according to each of Examples 1 and 2 and comparative examples 1 and 2 was measured with an outer diameter measurer (LS-3100 by Keyence Corporation), and the paper feed roller 1 was set in a monochromatic composite machine (Vivace 455 by Fuji Xerox Co., Ltd.), and 50000 plain copy papers (product name: FLYING by Tianjin Hines Cultural Products Co., Ltd.; 161st, Anshan West Road, Nankai District, Tianjin, China) were fed therethrough. Thereafter the outer diameter of the paper feed roller 1 was remeasured similarly to the above to obtain outer diameter loss resulting from friction caused by the paper feeding, and the abrasion resistance was evaluated with the following criteria:

◯: The outer diameter loss was not more than 0.05 mm, and the abrasion resistance was excellent.

×: The outer diameter loss was in excess of 0.05 mm, and the abrasion resistance was inferior.

(Measurement of Friction Coefficient)

The roller body 2 of each of the paper feed rollers 1 formed according to Examples 1 and 2 and comparative examples 1 and 2 was brought into pressure contact with a surface of a Teflon flat plate, so set that the surface was horizontal, with a vertical load of 0.98N applied from above, and a rectangular measurement paper having a length of 210 mm in a paper feeding direction and a width of 60 mm in a direction orthogonal to the paper feeding direction was set between the paper feed roller 1 and the flat plate. The measurement paper was prepared by cutting a copy paper BF500 by Canon Inc. into the aforementioned size.

Then, the paper feed roller 1 was rotated at a peripheral speed of 50 mm/sec. in the state brought into pressure contact with the surface of the flat plate with the vertical load of 0.98 N (=0.1 kgf) applied from above, and transport force F for the measurement paper was measured with a load cell. Then, a friction coefficient μ was obtained by multiplying the transport force F by 0.1. The transport force F was measured twice before the abrasion resistance test (in an initial stage) and after the abrasion resistance test (after a durability test).

(Bleeding Test)

The friction coefficient μ is reduced when the plasticizer bleeds on the surface of the roller body 2, and hence the air heating aging test and the accelerated aging test A-1 (testing temperature: 70±1° C.) defined in JIS K6257:2003 “rubber, vulcanized or thermoplastic—determination of heat aging properties” were conducted on each of the paper feed rollers 1 formed according to Examples 1 and 2 and comparative examples 1 and 2, to obtain the friction coefficient μ before and after the tests under conditions identical to the above respectively. The presence or absence of bleeding was evaluated with the following criteria:

◯: The initial friction coefficient μ was not less than 0.6, and the rate of change of the friction coefficient μ after the aging tests was less than 10%. No bleeding was observed.

×: The initial friction coefficient μ was less than 0.6, or the rate of change of the friction coefficient μ after the aging tests was not less than 10%. Bleeding was observed.

Table 1 shows the results.

TABLE 1

| | | | Comp. | | | Comp. |
|---|---|---|---|---|---|---|
| | | | Ex. 1 | EX. 2 | Ex. 1 | Ex. 2 |
| Parts | Thermoplastic | MD = 98 | 90 | — | — | — |
| by | Elastomer | MD = 90 | — | 90 | — | — |
| Mass | Urethane | MD = 80 | — | — | 80 | — |
| | | MD = 70 | — | — | — | 80 |
| | Plasticizer | Benzoflex | 10 | 10 | 20 | 20 |
| Evaluation | Moldability | | ◯ | ◯ | ◯ | ◯ |
| | Microrubber Hardness | | 98 | 85 | 70 | 60 |
| | Abrasion Resistance | | — | ◯ | ◯ | X |
| | Friction | Initial | 0.5 | 1.2 | 1.3 | — |
| | Coefficient | Stage | | | | |
| | | After | — | 1.0 | 1.0 | — |
| | | Durability | | | | |
| | | Test | | | | |

| | | | | |
|---|---|---|---|---|
| Bleeding | X | ◯ | ◯ | ◯ |

Comparative Example 1 caused bleeding when the plasticizer was blended in a large quantity.
MD: Microrubber Hardness (Type A)

It has been recognized from the results of comparative example 1 shown in Table 1 that the microrubber hardness (type A) of the roller body 2 made of the TPU cannot be set to not more than 90 when the mass ratio E/P of the thermoplastic elastomer urethane and the plasticizer is 90/10 if the microrubber hardness (type A) of the thermoplastic elastomer urethane forming the TPU exceeds 95. A large quantity of plasticizer had to be blended in excess of the mass ratio E/P of 90/10 in order to set the microrubber hardness (type A) of the roller body 2 to not more than 90, and the excess plasticizer bled in this case.

It has also been recognized from the results of comparative example 2 that the abrasion resistance is reduced and the friction coefficient is remarkably reduced after the durability test if a soft thermoplastic elastomer urethane whose own microrubber hardness (type A) is less than 80 is employed.

On the other hand, it has been confirmed from the results of each of Examples 1 and 2 that the TPU prepared by blending the thermoplastic elastomer urethane having microrubber hardness (type A) of not less than 80 and not more than 95 and the plasticizer with each other has excellent moldability while the roller body 2 of the paper feed roller 1 formed by the TPU exhibits microrubber hardness (type A) of not more than 90, is flexible, and has an excellent friction coefficient. It has also been confirmed that the roller body 2 allows use over a long period due to the excellent abrasion resistance and causes no bleeding of the plasticizer.

### Examples 3 and 4

Pellets of TPUs were manufactured to form paper feed rollers 1 similarly to Example 1, except that polyethylene glycol diester (Sanflex (registered trademark) EB300 by Sanyo Chemical Industries, Ltd.) (Example 3) corresponding to mono- or more oxyalkylene glycol diester and bis(2-methoxyethyl)phthalate (DMEP, Example 4) corresponding to phthalic acid having an oxyalkylene structure were employed as plasticizers. In each TPU, the mass ratio E/P of the thermoplastic elastomer urethane and the plasticizer was 80/20.

### Comparative Examples 3 and 4

Pellets of TPUs were manufactured to form paper feed rollers 1 similarly to Example 1, except that diisodecyl adipate (DIDA, aliphatic dibasic acid-based, comparative example 3) and carbonate synthetic oil (barrel process oil M18 by Matsumura Oil Co., Ltd.) (comparative example 4), each neither ether ester-based nor phthalic ester-based, were employed as plasticizers. In each TPU, the mass ratio E/P of the thermoplastic elastomer urethane and the plasticizer was 80/20.

The characteristics of the pellets of the TPUs and the paper feed rollers 1 manufactured according to Examples 3 and 4 and comparative examples 3 and 4 were evaluated by conducting the aforementioned tests. Table 2 shows the results along with those of Example 1.

TABLE 2

| | | | | | | Comp. | Comp. |
|---|---|---|---|---|---|---|---|
| | | | EX. 1 | EX. 3 | EX. 4 | Ex. 3 | Ex. 4 |
| Parts by Mass | Thermoplastic | MD = 80 | 80 | 80 | 80 | 80 | 80 |
| | Elastomer | | | | | | |
| | Urethane | | | | | | |
| | Plasticizer | Benzoflex | 20 | — | — | — | — |
| | | EB300 | — | 20 | — | — | — |
| | | DMEP | — | — | 20 | — | — |
| | | DIDA | — | — | — | 20 | — |
| | | M18 | — | — | — | — | 20 |
| Evaluation | Moldability | | ◯ | ◯ | ◯ | — | — |
| | Microrubber Hardness | | 70 | 70 | 70 | — | — |
| | Abrasion Resistance | | ◯ | ◯ | ◯ | — | — |
| | Friction | Initial Stage | 1.3 | 1.4 | 1.2 | — | — |
| | Coefficient | After | 1.0 | 1.2 | 1.1 | — | — |
| | | Durability | | | | | |
| | | Test | | | | | |

| | | | | | |
|---|---|---|---|---|---|
| Bleeding | ◯ | ◯ | ◯ | X | X |

MD: Microrubber Hardness (Type A)

It has been recognized from the results of Examples 1, 3 and 4 and comparative examples 3 and 4 shown in Table 2 that the plasticizer combined with the ester thermoplastic elastomer urethane must be at least one plasticizer selected from the group consisting of the ether ester plasticizer and the phthalic ester plasticizer, in order to further improve the friction coefficient with respect to papers by improving the flexibility while maintaining the excellent abrasion resistance of the roller body 2 of the paper feed roller 1.

### Examples 5 and 6 and Comparative Examples 5 and 6

Pellets of TPUs were manufactured to form paper feed rollers 1 similarly to Example 1, except that the mass ratio E/P of the pellet of the thermoplastic elastomer urethane prepared according to synthetic example 1 and diisopropylene glycol dibenzoate as an ether ester plasticizer was set to 98/2 (comparative example 5), 90/10 (Example 5), 70/30 (Example 6) and 50/50 (comparative example 6) respectively.

The characteristics of the pellets of the TPUs and the paper feed rollers 1 manufactured according to Examples 5 and 6 and comparative examples 5 and 6 were evaluated by conducting the aforementioned tests. Table 3 shows the results along with those of Example 1.

TABLE 3

| | | | Comp. | | | | Comp. |
|---|---|---|---|---|---|---|---|
| | | | Ex. 5 | EX. 5 | EX. 1 | EX. 6 | Ex. 6 |
| Parts by Mass | Thermoplastic | MD = 80 | 98 | 90 | 80 | 70 | 50 |
| | Elastomer | | | | | | |
| | Urethane <E> | | | | | | |
| | Plasticizer <P> | Benzoflex | 2 | 10 | 20 | 30 | 50 |
| | Mass Ratio E/P | | 98/2 | 90/10 | 80/20 | 70/30 | 50/50 |
| Evaluation | Moldability | | ◯ | ◯ | ◯ | ◯ | ◯ |
| | Microrubber Hardness | | 79 | 75 | 70 | 60 | 40 |
| | Abrasion Resistance | | ◯ | ◯ | ◯ | ◯ | X |
| | Friction | Initial Stage | 1.0 | 1.2 | 1.3 | 1.3 | 2.0 |
| | Coefficient | After | 0.3 | 1.0 | 1.0 | 1.1 | 1.6 |
| | | Durability | | | | | |
| | | Test | | | | | |

| | | | | | |
|---|---|---|---|---|---|
| Bleeding | ◯ | ◯ | ◯ | ◯ | ◯ |

MD: Microrubber Hardness (Type A)

It has been recognized from the results of comparative example 5 shown in Table 3 that the quantity of the plasticizer is so insufficient that the friction coefficient is remarkably reduced after the durability test of the roller body 2 if the mass ratio E/P is 98/2. It has also been recognized from the results of comparative example 6 that the abrasion resistance is inferior if the mass ratio E/P is 50/50.

On the other hand, it has been confirmed from the results of each of Examples 1, 5 and 6 that the TPU having the mass ratio E/P of 95/5 to 70/30 has excellent moldability while the roller body 2 of the paper feed roller 1 formed by the TPU has an excellent friction coefficient due to the flexibility, allows use over a long period due to the excellent abrasion resistance, and causes no bleeding of the plasticizer.

### Synthetic Example 5

Polytetramethylene glycol (number average molecular weight Mn=2000) as polyether polyol was heated to 110° C. under reduced pressure of 5 hPa and dehydrated for one hour.

Then, 160.6 parts by mass of 1,4-butanediol as a chain extender was mixed into 2000 parts by mass of the polytetramethylene glycol and the mixture was stirred under heating to 80° C., while 696.5 parts by mass of 4,4′-diphenylmethane diisocyanate as diisocyanate and 15.6 parts by mass of Irganox 1010 (registered trademark) by Ciba Specialty Chemicals Inc. as an antioxidant separately heated to 50° C. were added to the mixture, which in turn was further continuously stirred.

When the reaction temperature reached 110° C., the mixture was poured onto a hot plate covered with glass fiber cloth processed with Teflon and heated to 125° C., and the reaction product was annealed in a drying chamber of 100° C. for 15 hours, pulverized and thereafter pelletized, to prepare a pellet of an ether thermoplastic elastomer urethane.

The microrubber hardness (type A) of the thermoplastic elastomer urethane obtained similarly to the above was 80. The compounding ratio of the components obtained according to the formula (1) was 30.0.

### Synthetic Example 6

A pellet of an ether thermoplastic elastomer urethane was prepared similarly to synthetic example 5, except that the quantities of 1,4-butanediol and 4,4′-diphenylmethane diisocyanate were set to 255.5 parts by mass and 960.0 parts by mass respectively. The microrubber hardness (type A) of the thermoplastic elastomer urethane obtained similarly to the above was 90. The compounding ratio of the components obtained according to the formula (1) was 37.8.

### Synthetic Example 7

A pellet of an ether thermoplastic elastomer urethane was prepared similarly to synthetic example 5, except that the quantities of 1,4-butanediol and 4,4′-diphenylmethane diisocyanate were set to 104.6 parts by mass and 540.9 parts by mass respectively. The microrubber hardness (type A) of the thermoplastic elastomer urethane obtained similarly to the above was 70. The compounding ratio of the components obtained according to the formula (1) was 24.4.

### Synthetic Example 8

A pellet of an ether thermoplastic elastomer urethane was prepared similarly to synthetic example 5, except that the quantities of 1,4-butanediol and 4,4′-diphenylmethane diisocyanate were set to 323.4 parts by mass and 1148.8 parts by mass respectively. The microrubber hardness (type A) of the thermoplastic elastomer urethane obtained similarly to the above was 98. The compounding ratio of the components obtained according to the formula (1) was 42.4.

### Example 7

80 parts by mass of the pellet of the thermoplastic elastomer urethane prepared according to synthetic example 5 and 20 parts by mass of diisopropylene glycol dibenzoate (the aforementioned Benzoflex 988) as a plasticizer were introduced into a pail and heated in an oven of 80° C. for 15 hours to impregnate the plasticizer into the pellet. Thereafter the total contents of the pail were supplied to a double-screw extruder (screw diameter: 30 mm, L/D: 36D, number of revolutions: 10 to 300 rpm), milled and continuously extruded with the double-screw extruder, and thereafter pelletized again to manufacture a pellet of the TPU. The mass ratio E/P of the thermoplastic elastomer urethane and the plasticizer was 80/20.

Then, the pellet was supplied to a 50-ton injection molder (by Sumitomo Heavy Industries, Ltd.), milled with the injection molder, injected into the mold in a heated and melted state, cooled, solidified and thereafter demolded to form a cylindrical roller body 2 having an outer diameter of 14 mm, an inner diameter of 7.7 mm and an axial length of 40 mm, as shown in FIG. 1.

Then, a temporary shaft having a diameter of 8 mm was press-fitted into a through-hole 3 of the roller body 2, the roller body 2 was cut into an axial length of 25 mm, and a stainless steel shaft 4 having a diameter of 8 mm was press-fitted into the through-hole 3 again. An outer peripheral surface 5 of the roller body 2 was polished until the outer diameter reached 12.7 mm, to form a paper feed roller 1. The rubber hardness of the roller body 2 was 2.35 mm.

### Example 8 and Comparative Example 7

Pellets of TPUs were manufactured to form paper feed rollers 1 similarly to Example 7, except that the pellets of the thermoplastic elastomer urethanes prepared according to synthetic example 6 (Example 8) and synthetic example 8 (comparative example 7) were employed respectively while the quantities of each of the pellets and diisopropylene glycol dibenzoate as an ether ester plasticizer were set to 90 parts by mass and 10 parts by mass respectively. In each pellet, the mass ratio E/P of the thermoplastic elastomer urethane and the plasticizer was 90/10.

### Comparative Example 8

A pellet of a TPU was manufactured similarly to Example 7, except that the pellet of the thermoplastic elastomer urethane prepared according to synthetic example 7 was employed. The mass ratio E/P of the thermoplastic elastomer urethane and the plasticizer was 80/20.

The characteristics of the pellets of the TPUs and the paper feed rollers 1 manufactured according to Examples 7 and 8 and comparative examples 7 and 8 were evaluated by conducting the aforementioned tests. Table 4 shows the results.

TABLE 4

| | | | Comp. | | | Comp. |
|---|---|---|---|---|---|---|
| | | | Ex. 7 | EX. 8 | EX. 7 | Ex. 8 |
| Parts | Thermoplastic | MD = 98 | 90 | — | — | — |
| by | Elastomer | MD = 90 | — | 90 | — | — |
| Mass | Urethane | MD = 80 | — | — | 80 | — |
| | | MD = 70 | — | — | — | 80 |
| | Plasticizer | Benzoflex | 10 | 10 | 20 | 20 |
| Evaluation | Moldability | | ◯ | ◯ | ◯ | ◯ |
| | Microrubber Hardness | | 98 | 85 | 70 | 60 |
| | Abrasion Resistance | | — | ◯ | ◯ | X |
| | Friction | Initial | 0.5 | 1.2 | 1.3 | 1.3 |
| | Coefficient | Stage | | | | |
| | | After | — | 1.0 | 1.0 | 1.0 |
| | | Durability | | | | |
| | | Test | | | | |

| | | | | |
|---|---|---|---|---|
| Bleeding | X | ◯ | ◯ | ◯ |

Comparative Example 8 caused bleeding when the plasticizer was blended in a large quantity.
MD: Microrubber Hardness (Type A)

It has been recognized from the results of comparative example 7 shown in Table 4 that the microrubber hardness (type A) of the roller body 2 made of the TPU cannot be set to not more than 90 when the mass ratio E/P of the thermoplastic elastomer urethane and the plasticizer is 90/10 if the microrubber hardness (type A) of the thermoplastic elastomer urethane forming the TPU exceeds 95. A large quantity of plasticizer had to be blended in excess of the mass ratio E/P of 90/10 in order to set the microrubber hardness (type A) of the roller body 2 to not more than 90, and the excess plasticizer bled in this case. Therefore, the tests other than the hardness test and the bleeding test were not conducted.

It has also been recognized from the results of comparative example 8 that the abrasion resistance is reduced and the friction coefficient is remarkably reduced after the durability test if a soft thermoplastic elastomer urethane whose own microrubber hardness (type A) is less than 80 is employed.

On the other hand, it has been confirmed from the results of each of Examples 7 and 8 that the TPU prepared by blending the thermoplastic elastomer urethane having microrubber hardness (type A) of not less than 80 and not more than 95 and the plasticizer with each other has excellent moldability while the roller body 2 of the paper feed roller 1 formed by the TPU exhibits microrubber hardness (type A) of not more than 90, is flexible, has an excellent friction coefficient, allows use over a long period due to the excellent abrasion resistance, and causes no bleeding of the plasticizer.

### Examples 9 to 11

Pellets of TPUs were manufactured to form paper feed rollers 1 similarly to Example 7, except that polyethylene glycol diester (Sanflex (registered trademark) EB 300 by Sanyo Chemical Industries, Ltd.) (Example 9) corresponding to mono- or more oxyalkylene glycol diester, bis(2-methoxyethyl)phthalate (DMEP, Example 10) corresponding to phthalic ester having an oxyalkylene structure, and tributhoxyethyl phosphate (TBP, Example 11) corresponding to phosphoric ester were employed as plasticizers. In each case, the mass ratio E/P of the thermoplastic elastomer urethane and the plasticizer was 80/20.

### Comparative Examples 9 and 10

Pellets of TPUs were manufactured to form paper feed rollers 1 similarly to Example 7, except that diisodecyl adipate (DIDA, aliphatic dibasic acid-based, comparative example 9) and carbonate synthetic oil (barrel process oil M18 by Matsumura Oil Co., Ltd.) (comparative example 10) each neither ether ester-based, nor phthalic ester-based nor phosphoric acid-based, were employed as plasticizers. In each case, the mass ratio E/P of the thermoplastic elastomer urethane and the plasticizer was 80/20.

The characteristics of the pellets of the TPUs and the paper feed rollers 1 manufactured according to Examples 9 to 11 and comparative examples 9 and 10 were evaluated by conducting the aforementioned tests. Table 5 shows the results along with those of Example 7.

TABLE 5

| | | | | | | | Comp. | Comp. |
|---|---|---|---|---|---|---|---|---|
| | | | Ex. 7 | Ex. 9 | Ex. 10 | Ex. 11 | Ex. 9 | Ex. 10 |
| Parts | Thermoplastic | MD = 80 | 80 | 80 | 80 | 80 | 80 | 80 |
| by | Elastomer | | | | | | | |
| Mass | Urethane | | | | | | | |
| | Plasticizer | Benzoflex | 20 | — | — | — | — | — |
| | | EB300 | — | 20 | — | — | — | — |
| | | DMEP | — | — | 20 | — | — | — |
| | | TBP | — | — | — | 20 | — | — |
| | | DIDA | — | — | — | — | 20 | — |
| | | M18 | — | — | — | — | — | 20 |
| Evaluation | Moldability | | ◯ | ◯ | ◯ | ◯ | — | — |
| | Microrubber Hardness | | 70 | 70 | 70 | 70 | — | — |
| | Abrasion Resistance | | ◯ | ◯ | ◯ | ◯ | — | — |
| | Friction | Initial Stage | 1.3 | 1.4 | 1.2 | 1.3 | — | — |
| | Coefficient | After | 1.0 | 1.2 | 1.1 | 1.1 | — | — |
| | | Durability | | | | | | |
| | | Test | | | | | | |

| | | | | | | |
|---|---|---|---|---|---|---|
| Bleeding | ◯ | ◯ | ◯ | ◯ | X | X |

MD: Microrubber Hardness (Type A)

It has been recognized from the results of Examples 7 and 9 to 11 and comparative examples 9 and 10 shown in Table 5 that the plasticizer combined with the ether thermoplastic elastomer urethane must be at least one plasticizer selected from the group consisting of the ether ester plasticizer, the phthalic ester plasticizer and the phosphoric acid plasticizer, in order to further improve the friction coefficient with respect to papers by improving the flexibility while maintaining the excellent abrasion resistance of the roller body 2 of the paper feed roller 1.

### Examples 12 and 13 and Comparative Examples 11 and 12

Pellets of TPUs were manufactured to form paper feed rollers 1 similarly to Example 7, except that the mass ratio E/P of the thermoplastic elastomer urethane prepared according to synthetic example 5 and diisopropylene glycol dibenzoate as an ether ester plasticizer was set to 98/2 (comparative example 11), 90/10 (Example 12), 70/30 (Example 13) and 50/50 (comparative example 12) respectively.

The characteristics of the pellets of the TPUs and the paper feed rollers 1 manufactured according to Examples 12 and 13 and comparative examples 11 and 12 were evaluated by conducting the aforementioned tests. Table 6 shows the results along with those of Example 7.

TABLE 6

| | | | Comp. | | | | Comp. |
|---|---|---|---|---|---|---|---|
| | | | Ex. 11 | Ex. 12 | Ex. 7 | Ex. 13 | Ex. 12 |
| Parts | Thermoplastic | MD = 80 | 98 | 90 | 80 | 70 | 50 |
| by | Elastomer | | | | | | |
| Mass | Urethane <E> | | | | | | |
| | Plasticizer <P> | Benzoflex | 2 | 10 | 20 | 30 | 50 |
| | Mass Ratio E/P | | 98/2 | 90/10 | 80/20 | 70/30 | 50/50 |
| Evaluation | Moldability | | ◯ | ◯ | ◯ | ◯ | ◯ |
| | Microrubber Hardness | | 79 | 75 | 70 | 60 | 40 |
| | Abrasion Resistance | | ◯ | ◯ | ◯ | ◯ | X |
| | Friction | Initial Stage | 1.0 | 1.2 | 1.3 | 1.3 | 1.9 |
| | Coefficient | After | 0.3 | 1.0 | 1.0 | 1.1 | 1.4 |
| | | Durability | | | | | |
| | | Test | | | | | |

| | | | | | |
|---|---|---|---|---|---|
| Bleeding | ◯ | ◯ | ◯ | ◯ | ◯ |

MD: Microrubber Hardness (Type A)

It has been recognized from the results of comparative example 11 shown in Table 6 that the quantity of the plasticizer is so insufficient that the friction coefficient is remarkably reduced after the durability test of the roller body 2 if the mass ratio E/P is 98/2. It has also been recognized from the results of comparative example 12 that the abrasion resistance is inferior if the mass ratio E/P is 50/50.

On the other hand, it has been confirmed from the results of each of Examples 7, 12 and 13 that the TPU having the mass ratio E/P of 95/5 to 70/30 has excellent moldability while the roller body 2 of the paper feed roller 1 formed by the TPU exhibits microrubber hardness (type A) of not more than 90, is flexible and has an excellent friction coefficient. It has also been confirmed that the roller body 2 allows use over a long period due to the excellent abrasion resistance and causes no bleeding of the plasticizer.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2009-185747 filed with the Japan Patent Office on Aug. 10, 2009, the disclosure of which is incorporated herein by reference.

What is claimed is:

1. A paper feed roller made of:
(1) a thermoplastic elastomer composition containing an ester thermoplastic elastomer urethane (E) having microrubber hardness (type A) of not less than 80 and not more than 95 and at least one plasticizer (P) selected from a group consisting of an ether ester plasticizer and a phthalic ester plasticizer in a mass ratio E/P of 95/5 to 70/30, or
(2) a thermoplastic elastomer composition containing an ether thermoplastic elastomer urethane (E) having microrubber hardness (type A) of not less than 80 and not more than 95 and at least one plasticizer (P) selected from a group consisting of an ether ester plasticizer, a phthalic ester plasticizer and a phosphoric acid plasticizer in a mass ratio E/P of 95/5 to 70/30.

2. The paper feed roller according to claim 1, wherein
the thermoplastic elastomer urethane is the ester thermoplastic elastomer urethane, and the plasticizer is at least one selected from a group consisting of mono- or more oxyalkylene glycol diester and phthalic diester having an oxyalkylene skeleton.

3. The paper feed roller according to claim 2, wherein
the mono- or more oxyalkylene glycol diester is at least one selected from a group consisting of dipropylene glycol dibenzoate and polyethylene glycol diester.

4. The paper feed roller according to claim 1, wherein
the thermoplastic elastomer urethane is the ether thermoplastic elastomer urethane, and the plasticizer is at least one selected from a group consisting of mono- or more oxyalkylene glycol diester, phthalic diester having an oxyalkylene skeleton, aliphatic dibasic acid diester and phosphoric ester.

5. The paper feed roller according to claim 4, wherein
the mono- or more oxyalkylene glycol diester is at least one selected from a group consisting of dipropylene glycol dibenzoate and polyethylene glycol diester.

6. The paper feed roller according to claim 1, wherein
the thermoplastic elastomer urethane is an addition polymer of diisocyanate, macropolyol and a chain extender, and the compounding ratio of the components constituting the addition polymer satisfies the following formula (1):
30≦(x+z)/(x+y+z)×100≦40 (1)
(where x, y and z represent the loadings of diisocyanate, macropolyol and the chain extender respectively).

7. The paper feed roller according to claim 1, wherein
the microrubber hardness (type A) is not less than 60 and not more than 90.
